(19) United States
(12) Patent Application Publication
(10) Pub. No.: US 2022/0204831 A1
(43) Pub. Date: Jun. 30, 2022

(54) THERMALLY CONDUCTIVE SILICONE COMPOSITION, SHEET USING THE SAME, AND METHOD FOR PRODUCING THE SHEET

(71) Applicants: Fuji Polymer Industries Co., Ltd., Nagoya-shi (JP); Sulfur Chemical Laboratory Inc., Morioka-shi (JP)

(72) Inventors: Tomoyuki OKUMURA, Aichi (JP); Keisuke KAWAHAMA, Aichi (JP); Kunio MORI, Iwate (JP)

(21) Appl. No.: 17/695,201

(22) Filed: Mar. 15, 2022

Related U.S. Application Data
(63) Continuation of application No. PCT/JP2021/020673, filed on May 31, 2021.

(30) Foreign Application Priority Data
Nov. 16, 2020 (JP) 2020-190489

(51) Int. Cl. C09K 5/14; C08G 77/20; C08G 77/08; C08K 9/04; C08J 5/18

(52) U.S. Cl. CPC C09K 5/14; C08G 77/20; C08G 77/08; C08J 2383/07; C08J 5/18; C08K 2201/001; C08K 2201/005; C08K 9/04

(57) ABSTRACT

A composition of the present invention contains the following components A to C: A. a linear terminal-reactive polydimethylsiloxane; B. a thermally conductive filler including the following B1, B2, and B3 in an amount of 800 to 2500 parts by mass with respect to 100 parts by mass of the component A; and C. a curing catalyst in a catalytic amount. The component B includes the following: B1. a thermally conductive filler that has an average particle size of 0.1 to 1.0 μm and is surface treated with a surface treatment agent containing a reactive group having no unsaturated bond; B2. a thermally conductive filler that has an average particle size of 1.0 to 10 μm and is surface treated with a surface treatment agent containing a reactive group having an unsaturated bond; and B3. a thermally conductive filler that has an average particle size of 10 to 100 μm and is surface treated with the surface treatment agent containing a reactive group having no unsaturated bond or the surface treatment agent containing a reactive group having an unsaturated bond. Thus, the thermally conductive silicone composition and the sheet formed by using this composition have a high strength.

### TECHNICAL FIELD

The present invention relates to a thermally conductive silicone composition and a thermally conductive silicone sheet that are suitable to be interposed between a heat generating member and a heat dissipating material of electrical and electronic components or the like, and a method for producing the thermally conductive silicone sheet.

### BACKGROUND ART

With the significant improvement in performance of semiconductor devices such as CPUs in recent years, the amount of heat generated by them has become extremely large. For this reason, heat dissipating materials are attached to electronic components such as semiconductor devices that may generate heat, and a thermally conductive silicone sheet is used to improve the adhesion between the heat dissipating materials and the semiconductor devices. Conventional transistors and capacitors (for power supply etc.) have been used with heat dissipating caps and sheets that are of the addition reaction curable millable type. Such heat dissipating members are also required to have higher thermal conductive properties due to a recent increase in the amount of heat generated. Patent Documents 1 to 3 propose a thermally conductive silicone sheet that is used in combination with a reinforcement material such as glass doth to improve ease of handling.

### PRIOR ART DOCUMENTS

### Patent Documents

Patent Document 1: JPWO 2018-061447 A1
Patent Document 2: JPWO 2018-020862 A1
Patent Document 3: JP 2017-222884A

### DISCLOSURE OF INVENTION

### Problem to be Solved by the Invention

However, the conventional thermally conductive silicone sheet combined with the reinforcement material such as glass cloth has a large thermal resistance. This has posed a major problem in the development of high thermally conductive products.

To solve these conventional problems, the present invention provides a sheet of a thermally conductive silicone composition that has a high strength and can be handled satisfactorily without the use of a reinforcement sheet such as glass cloth, and a method for producing the sheet of the thermally conductive silicone composition.

### Means for Solving Problem

A thermally conductive silicone composition of the present invention contains the following components A to C:

A. a linear terminal-reactive polydimethylsiloxane;

B. a thermally conductive filler including the following B-1, B-2, and B-3 in an amount of 800 to 2500 parts by mass with respect to 100 parts by mass of the component A and

C. a curing catalyst in a catalytic amount.

B-1 is a thermally conductive filler that has an average particle size of 0.1 μm or more and less than 1.0 μm and is surface treated with a surface treatment agent containing a reactive group having no unsaturated bond.

B-2 is a thermally conductive filler that has an average particle size of 1.0 μm or more and less than 10 μm and is surface treated with a surface treatment agent containing a reactive group having an unsaturated bond.

B-3 is a thermally conductive filler that has an average particle size of 10 μm or more and 100 μm or less and is surface treated with at least one selected from the surface treatment agent containing a reactive group having no unsaturated bond and the surface treatment agent containing a reactive group having an unsaturated bond.

A thermally conductive silicone sheet of the present invention includes the thermally conductive silicone composition described above. The thermally conductive silicone composition is molded into a sheet and the sheet is thermally cured. A tensile strength of the thermally conductive silicone sheet is 5 MPa or more.

A method for producing a thermally conductive silicone sheet of the present invention includes uniformly mixing the composition containing the components A to C, molding the composition into a sheet, and thermally curing the sheet.

### Effects of the Invention

The thermally conductive silicone composition of the present invention contains the components A to C, and thus can have a high strength and be handled satisfactorily without the use of a reinforcement sheet such as glass doth when the composition is formed into a sheet. The thermally conductive silicone sheet of the present invention is configured such that the thermally conductive silicone composition is molded into a sheet and the sheet is thermally cured. With this configuration, the thermally conductive silicone sheet can have a tensile strength of 5 MPa or more and a thermal conductivity of 1 W/m·K or more. The production method of the present invention can efficiently and reasonably produce the thermally conductive silicone sheet even at a low cost.

### BRIEF DESCRIPTION OF DRAWINGS

FIGS. 1A to 1B are diagrams illustrating a method for measuring a thermal conductivity of a sample in an example of the present invention.

FIG. 2 is a schematic diagram illustrating a spherical particle of a thermally conductive filler.

### DESCRIPTION OF THE INVENTION

A thermally conductive silicone composition of the present invention contains the following components A to C:

A. a linear terminal-reactive polydimethylsiloxane in an amount of 100 parts by mass;

B. a thermally conductive filler inducting the following B-1, B-2, and B-3 in an amount of 800 to 2500 parts by mass; and

C. a curing catalyst in a catalytic amount.

B-1 is a thermally conductive filler that has an average particle size of 0.1 μm or more and less than 1.0 μm and is surface treated with a surface treatment agent containing a reactive group having no unsaturated bond.

B-2 is a thermally conductive filler that has an average particle size of 1.0 μm or more and less than 10 μm and is surface treated with a surface treatment agent containing a reactive group having an unsaturated bond.

B-3 is a thermally conductive filler that has an average particle size of 10 μm or more and 100 μm or less and is surface treated with at least one selected firm the surface treatment agent containing a reactive group having no unsaturated bond and the surface treatment agent containing a reactive group having an unsaturated bond.

The component A is preferably a linear organopolysiloxane that has a reactive group at each end of the molecular chain and organic groups such as alkyl group and phenyl group, or a combination of these groups, on side chains. The linear organopolysiloxane may include a small amount of branched structure (trifunctional siloxane units) in the molecule. An example of the component A may be a compound in which the main chain is dimethylpolysiloxane and at least both ends are terminated by dimethylvinylsiloxy groups. When the component A is a linear organopolysiloxane having a vinyl group at each end of the molecular chain, the thermally conductive silicone composition can exhibit flexibility, and also the molecular chain remains linear after curing.

Specific examples of the component A include the following: dimethylpolysiloxane with both ends of the molecular chain terminated by dimethylvinylsiloxy groups; dimethylpolysiloxane with both ends of the molecular chain terminated by methylphenylvinylsiloxy groups; a copolymer of dimethylsiloxane with both ends of the molecular chain terminated by dimethylvinylsiloxy groups and methylphenylsiloxane with both ends of the molecular chain terminated by dimethylvinylsiloxy groups; a copolymer of dimethylsiloxane with both ends of the molecular chain terminated by dimethylvinylsiloxy groups and methylvinylsiloxane with both ends of the molecular chain terminated by dimethylvinylsiloxy groups; a copolymer of dimethylsiloxane with both ends of the molecular chain terminated by trimethylsiloxy groups and methylvinylsiloxane with both ends of the molecular chain terminated by trimethylsiloxy groups; methyl(3,3,3-trifluoropropyl)polysiloxane with both ends of the molecular chain terminated by dimethylvinylsiloxy groups; a copolymer of dimethylsiloxane with both ends of the molecular chain terminated by silanol groups and methylvinylsiloxane with both ends of the molecular chain terminated by silanol groups; and a copolymer of dimethylsiloxane with both ends of the molecular chain terminated by silanol groups, methylvinylsiloxane with both ends of the molecular chain terminated by silanol groups, and methylphenylsiloxane with both ends of the molecular chain terminated by silanol groups. These polymers may be used alone or in combinations of two or more. In particular, a linear terminal-reactive polydimethylsiloxane represented by the following general formula (1) is preferred.

X[Si(CH₃)₂—O—]ₙSi(CH₃)₂—Y (1)

(where the degree of polymerization n is in the range of 5 to 2100 and the end groups X and Y are vinyl groups)

The thermally conductive filler used in the present invention is preferably composed of inorganic powder of, e.g., alumina (aluminum oxide), zinc oxide, silicon oxide, silicon carbide, aluminum nitride, or boron nitride. Alumina is preferred among them because it is inexpensive. The thermally conductive filler may be in any form, including spherical, irregular, needle-like, and plate-like. In particular, a spherical shape is preferred. The thermally conductive filler may be used alone or in combinations of two or more. The amount of the thermally conductive filler is 800 to 2500 parts by mass with respect to 100 parts by mass of the component A. This can improve the thermal conductivity.

The thermally conductive filler used in the present invention includes the following fillers with different average particle sizes, and each of the fillers is subjected to a particular surface treatment.

(1) B-1 is a thermally conductive filler that has an average particle size of 0.1 μm or more and less than 1.0 μm and is surface treated with a surface treatment agent containing a reactive group having no unsaturated bond.

(2) B-2 is a thermally conductive filler that has an average particle size of 1.0 μm or more and less than 10 μm and is surface treated with a surface treatment agent containing a reactive group having an unsaturated bond.

(3) B-3 is a thermally conductive filler that has an average particle size of 10 μm or more and 100 μm or less and is surface treated with at least one selected from the surface treatment agent containing a reactive group having no unsaturated bond and the surface treatment agent containing a reactive group having an unsaturated bond.

The reason for using the fillers with at least three different average particle sizes is that a base material is highly loaded with the fillers. The higher the filler loading, the higher the thermal conductivity. The average particle size is D50 (median diameter) in a volume-based cumulative particle size distribution measured by a laser diffraction scattering method. The method may use, e.g., a laser diffraction/scattering particle size distribution analyzer LA-950 S2 manufactured by HORIBA, Ltd.

The mixing ratio of B-1, B-2, and B-3 of the thermally conductive filler is preferably determined by (total surface area of B-3+total surface area of B-2)=k×(total cross section of B-1), where k is 1 to 5.

A balanced combination of the fillers with three different particle sizes B-1, B-2, and B-3 is required to achieve high loading of the fillers in the base material. When the particle size and the loading amount of each of the fillers are controlled so that the value k obtained from the above formula is within the range of 1 to 5, the fillers can be combined with a minimum space left between the particles. This arrangement can provide nearly closest packing and result in a high thermal conductivity.

The mixing ratio of B-1, B-2, and B-3 is preferably such that 150 to 450 parts by mass of B-1, 250 to 550 parts by mass of B-2, and 400 to 1500 parts by mass of B-3 are blended with respect to 100 parts by mass of the component A.

The filler B-1 has a small particle size and is surface treated with a surface treatment agent containing a reactive group having no unsaturated bond. The surface treatment agent preferably contains, e.g., an alkoxysiiane compound represented by the following general formula (2).

R²_{b}R³_{c}Si(OR⁴)_{4-b-c} (2)

(where R² independently represents an alkyl group having 6 to 15 carbon atoms, R³ independently represents a substituted or unsubstituted alkyl group having 1 to 12 carbon atoms, R⁴ independently represents an alkyl group having 1 to 6 carbon atoms, b represents an integer of 1 to 3, c represents an integer of 0 to 2, and b+c is an integer of 1 to 3.)

In the formula (2), examples of the alkyl group represented by R² include hexyl, octyl, nonyl, decyl, dodecyl, and tetradecyl groups. When the carbon number of the alkyl group represented by R² is in the range of 6 to 15, the thermally conductive filler has sufficiently high wettability and better handleability, so that the low-temperature properties of the thermally conductive silicone composition can be improved. Examples of substituted or unsubstituted monovalent hydrocarbon groups represented by R³ include the following: alkyl groups such as methyl, ethyl, propyl, isopropyl, butyl, isobutyl, tert-butyl, pentyl, neopentyl, hexyl, heptyl, octyl, nonyl, decyl, and dodecyl groups; cydoalkyl groups such as cydopentyl, cydohexyl, and cydoheptyl groups; aryl groups such as phenyl, tolyl, xylyl, naphthyl, and biphenyl groups; aralkyl groups such as benzyl, phenylethyl, phenylpropyl, and methylbenzyl groups; and substituted forms of these groups in which some or all carbon-bonded hydrogen atoms are substituted by halogen atoms (fluorine, chlorine, bromine, etc.) or cyano groups, including chloromethyl, 2-bromoethyl, 3-chloropropyl, 3,3,3-trifluoropropyl, chlorophenyl, fluorophenyl, cyanoethyl, and 3,3,4,4,5,5,6,6,6-nonafluorohexyl groups. The carbon number of the monovalent hydrocarbon groups is typically 1 to 10, and more typically 1 to 6. Preferred examples of the monovalent hydrocarbon groups include substituted or unsubstituted alkyl groups having 1 to 3 carbon atoms such as methyl, ethyl, propyl, chloromethyl, bromoethyl, 3,3,3-trifluoropropyl, and cyanoethyl groups, and substituted or unsubstituted phenyl groups such as phenyl, chlorophenyl, and fluorophenyl groups. Examples of the alkyl group represented by R⁴ include methyl, ethyl, propyl, isopropyl, butyl, isobutyl, tert-butyl, pentyl, neopentyl, and hexyl groups. In particular, the methyl group and the ethyl group are preferred. The alkoxysilane compound is also referred to as a silane coupling agent. The silane coupling agent may be used alone or in combinations of two or more.

The filler B-2 has a medium particle size and is surface treated with a surface treatment agent containing a reactive group having an unsaturated bond. The surface treatment agent preferably contains an alkoxysilane compound, as in the case of B-1.

R⁵_{b}R³_{c}Si(OR⁴)_{4-a-b-c} (3)

In the formula (3), R⁵ represents a reactive group having an unsaturated bond and may be, e.g., an alkenyl group, an acrylic group, a methacryloxy group, a vinyl group, or a styrene group.

The surface treatment agent has the unsaturated bond (carbon-carbon double bond). This unsaturated bond (carbon-carbon double bond) is cleaved and undergoes a crosslinking reaction with the component A when the thermally conductive silicone composition is heated and cured. Consequently, the strength of the thermally conductive silicone sheet is increased.

If the above reaction is also applied to the filler B-1 with a small particle size, the strength may further be increased, but the degree of plasticity of the thermally conductive silicone composition before heat curing will be extremely high, making it difficult to process the thermally conductive silicone composition. Thus, whether the surface treatment agent contains a reactive group having an unsaturated bond or not preferably depends on the particle size of the corresponding filler.

The filler B-3 has a large particle size and is surface treated with at least one selected from the surface treatment agent containing a reactive group having no unsaturated bond and the surface treatment agent containing a reactive group having an unsaturated bond.

The degree of plasticity of the thermally conductive silicone composition before curing is preferably 1 to 50. The degree of plasticity is measured in accordance with JIS K 6300-3, ISO 2007:1991. Using a Wallace plastometer, a sample is compressed between two metal plates under a predetermined load (100 N) for a predetermined time (15 sec) at a measurement temperature of 25° C. The degree of plasticity (P₀=t/t₀×100) is obtained by dividing the thickness (t) of the sample after the compression by the thickness (t₀) of the sample before the compression, and the smaller the value P₀, the more flexible the sample.

The curing catalyst is preferably an organic peroxide. The organic peroxide catalyzes the curing process via a free radical reaction. Examples of the organic peroxide include benzoyl peroxide, di(p-methylbenzoyl) peroxide, di(o-methylbenzoyl) peroxide, dicumyl peroxide, 2,5-dimethyl-2,5-bis(tert-butylperoxy)hexane, di-tert-butyl peroxide, and tert-butylperoxy benzoate. The organic peroxide is contained in an amount required for the curing of the composition of the present invention. Specifically, the content of the organic peroxide is preferably 0.5 to 30 parts by mass, and more preferably 1 to 20 parts by mass with respect to 100 parts by mass of the component A If the content of organic peroxide is less than the lower limit of the above range, the curing of the composition becomes insufficient, which may impair the sheet strength and accelerate oil bleeding. If the content of the organic peroxide is more than the upper limit of the above range, the resulting sheet may be brittle and cause foaming.

The thermally conductive silicone composition is molded into a sheet and the sheet is thermally cured, thereby forming a thermally conductive silicone sheet with a tensile strength of 5 MPa or more and a thermal conductivity of 1 W/m·K or more. The tensile strength is preferably 5 to 12 MPa, and more preferably 6 to 10 MPa. The thermal conductivity is preferably 1 to 8 W/m·K, and more preferably 2 to 5 W/m·K.

The thermally conductive silicone sheet may be combined with a reinforcement sheet such as glass cloth. In order to improve the thermal conductive properties, however, the thermally conductive silicone sheet should not include a reinforcement sheet. The thermally conductive silicone sheet of the present invention can not only have a strength that allows it to be handled satisfactorily without the use of a reinforcement sheet such as glass cloth, but also achieve flexibility, thermal conductive properties, mass productivity, and low cost.

The production method of the present invention includes uniformly mixing the composition containing the components A to C, molding the composition into a sheet, and thermally curing the sheet, so that a thermally conductive silicone sheet can be obtained. In the sheet molding process, the composition is preferably sandwiched between polyester films and then rolled. The thickness of the sheet is preferably 0.05 to 2 mm. In the thermal curing process, the sheet-like composition is preferably heat treated at 120 to 180° C. for 5 to 30 minutes.

The composition of the present invention may contain components other than the above as needed. For example, a heat resistance improver (such as colcothar, titanium oxide, or cerium oxide), a flame retardant auxiliary, and a curing retarder may be added. The curing retarder may be, e.g., ethynylcydohexanol. Moreover, an organic pigment or an inorganic particle pigment may be added for the purpose of coloring and toning.

### Examples

Hereinafter, the present invention will be described by way of examples. However, the present invention is not limited to the following examples. Various parameters were measured in the following manner.

<Degree of Plasticity>

The degree of plasticity was measured in accordance with JIS K 6300-3, ISO 2007:1991. Using a Wallace plastometer, a sample was compressed between two metal plates under a predetermined load (100 N) for a predetermined time (15 sec) at a measurement temperature of 25° C. The degree of plasticity (P₀=t/t₀×100) was obtained by dividing the thickness (t) of the sample after the compression by the thickness (t₀) of the sample before the compression, and the smaller the value P₀, the more flexible the sample.

<Tensile Strength>

The tensile strength was measured in the following manner. First, the cured sheets of the compositions of Examples and Comparative Examples were cut into No. 3 dumbbell specimens in accordance with JIS K 6251. Then, each of the specimens was stretched until fracture occurred and the tensile strength of the cured sheet was measured using Autograph AGS-X manufactured by SHIMADZU CORPORATION.

<Thermal Conductivity>

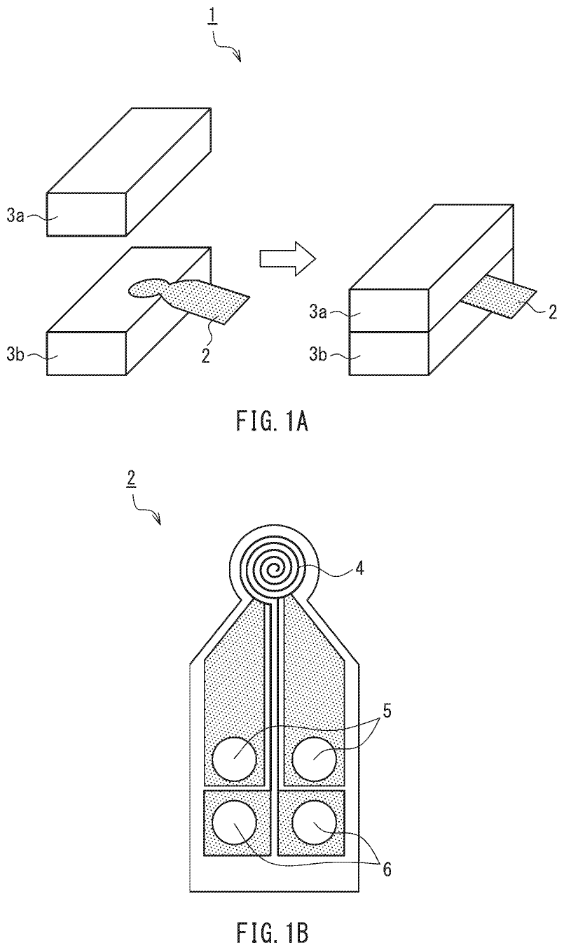

The thermal conductivity was measured by a hot disk (in accordance with ISO/CD 22007-2). As shown in FIG. 1A, using a thermal conductivity measuring apparatus 1, a polyimide film sensor 2 was sandwiched between two samples 3a, 3b, and constant power was applied to the sensor 2 to generate a certain amount of heat. Then, the thermal characteristics were analyzed from the value of a temperature rise of the sensor 2. The sensor 2 has a tip 4 with a diameter of 7 mm. As shown in FIG. 1B, the tip 4 has a double spiral structure of electrodes. Moreover, an electrode 5 for an applied current and an electrode 6 for a resistance value (temperature measurement electrode) are located on the lower portion of the sensor 2. The thermal conductivity was calculated by the following formula (1).

$$λ = \frac{Po \cdot D ( τ )}{{π}^{3 \text{/} 2} \cdot r} \cdot \frac{D ( τ )}{Δ T ( τ )} \qquad [ Formula 1 ]$$

λ: Thermal conductivity (W/m·K)

P₀: Constant power (W)

r: Radius of sensor (m)

τ: \sqrt{α·t/r²}

α: Thermal diffusivity of sample (m²/s)

t: Measuring time (s)

D(τ): Dimensionless function of τ

ΔT(τ): Temperature rise of sensor (K)

<Method for Calculating Value k of Thermally Conductive Filler>

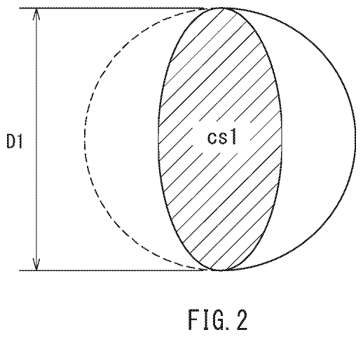

FIG. 2 is a schematic diagram illustrating a spherical particle of a thermally conductive filler. In FIG. 2, D1 represents a diameter of a particle and cs1 represents a cross section of the particle. The thermally conductive filler of the present invention can be expressed by (total surface area of B-3+total surface area of B-2)=k×(total cross section of B-1), which can be expanded as follows:

k=(total surface area of B-3+total surface area of B-2)/(total cross section of B-1)

k=(Σsa2+Σsa3)/Σcs1

Σcs1=cs1×q1

*cs1=(D½)2×π,q1=M1/(4/3×π×(D1/2)3×d1)

Σsa2=sa2×M2

Σsa3=sa3×M3

where Σcs1 is the sum of the cross sections of particles of B-1 (m²),

cs1 is the cross section of a particle of B-1 (m²),

q1 is the average particle number of B-1 (particle),

D1 is the average particle size of B-1 (m),

M1 is part by weight of B-1 (phr),

d1 is the density of B-1 (g/m³),

Σsa2 is the sum of the surface areas of particles of B-2 (m²),

sa2 is the surface area of a particle of B-2 (m²/g),

M2 is part by weight of B-2 (phr),

Σsa3 is the sum of the surface areas of particles of B-3 (m²),

sa3 is the surface area of a particle of B-3 (m²/g), and

M3 is part by weight of B-3 (phr).

Tables 1 shows the calculated values in Examples 1 to 6 and Comparative Examples 1 to 3.

TABLE 1

| | B-1 | B-2 | B-3 |
|---|---|---|---|
| Part by weigh: M (phr) | 300 | 400 | 800 |
| Specific surface area: sa (m²/g) | — | 1.8 | 1 |
| Density: d (g/m³) | 3.9 × 10⁶ | — | — |
| Average particle size: D (m) | 2.7 × 10⁻⁷ | — | — |
| Cross section: cs (m²) | 5.4 × 10⁻¹⁴ | — | — |
| Particle number: q (particle) | 7.5 × 10¹⁵ | — | — |
| Sum of cross sections: Σcs (m²) | 427 | — | — |
| Sum of surface areas: Σsa(m²) | — | 720 | 800 |

| | |
|---|---|
| K: Σsa/Σcs | 3.6 |

Tables 2 shows the calculated values in Examples 7 to 8 and Comparative Example 4.

TABLE 2

| | B-1 | B-2 | B-3 |
|---|---|---|---|
| Part by weigh: M (phr) | 300 | 400 | 800 |
| Specific surface area: sa (m²/g) | — | 1.1 | 0.2 |
| Density: d (g/m³) | 3.9 × 10⁶ | — | — |
| Average particle size: D (m) | 5.0 × 10⁻⁷ | — | — |
| Cross section: cs (m²) | 2.0 × 10⁻¹³ | — | — |
| Particle number: q (particle) | 1.2 × 10¹⁵ | — | — |
| Sum of cross sections: Σcs (m²) | 231 | — | — |
| Sum of surface areas: Σsa(m²) | — | 440 | 160 |

| | |
|---|---|
| K: Σsa/Σcs | 2.6 |

### Examples 1 to 8 and Comparative Examples 1 to 4

### 1. Material Components

### (1) Component a (Matrix Resin)

A-1: linear vinyl-terminated polydimethylsiloxane, molecular weight: 140000, degree of polymerization: 1891

A-2: linear vinyl-terminated polydimethylsiloxane, molecular weight: 72000, degree of polymerization: 972

### (2) Component B (Thermally Conductive Filler)

B-1-1: spherical alumina, average particle size: 0.27 μm, specific surface area: 6.7 m²/g, density: 3.9×10⁶ g/m³

B-1-2: spherical alumina, average particle size: 0.5 μm, specific surface area: 4.1 m²/g, density: 3.9×10⁶ g/m³

B-2-1: spherical alumina, average particle size: 21 μm, specific surface area: 1.8 m²/g, density: 3.9×10⁶ g/m³

B-2-2: spherical alumina, average particle size: 16 μm, specific surface area: 1.1 m²/g, density: 3.9×10⁶ g/m³

B-3-1: spherical alumina, average particle size: 18 μm, specific surface area: 1 m²/g, density: 3.9×10⁶ g/m³

B-3-2: spherical alumina, average particle size: 20.3 μm, specific surface area: 0.2 m²/g, density: 3.9×10⁶ g/m³

### (3) Component C (Curing Catalyst (Vulcanizing Agent))

50% paste of 2,5-dimethyl-2,5-bis(tert-butylperoxy)hexane

### 2. Surface Treatment of Component B

The component B (thermally conductive filler) to be treated was placed in a vessel of a Henschel mixer. A surface treatment solution obtained by diluting any of the following silane coupling agents with a 77% ethanol aqueous solution was added dropwise to the vessel and stirred for 5 minutes. Then, the filler was taken out of the vessel, transferred to a metal container, and dried in a circulating hot air oven at 130° C. for 2 hours. The weight of the silane coupling agent added to the component B (thermally conductive filler) was determined by the following formula.

Amount of silane coupling agent (g)=weight of filler (g)×specific surface area of filler (m²/g)÷minimum coverage area of silane coupling agent (m²/g)

Minimum coverage area of silane coupling agent (m²/g)=6.02×10²³×13×10⁻²⁰÷molecular weight of silane coupling agent

Surface treatment agent containing reactive group having no unsaturated bond: n-octyltrimethoxysilane (referred to as “octyl” in the following)

Surface treatment agent containing reactive group having no unsaturated bond: n-decyltrimethoxysilane (referred to as “decyl” in the following)

Surface treatment agent containing reactive group having unsaturated bond: 3-methacryloxypropyltrimethoxysilane (referred to as “methacryloxy” in the following)

Surface treatment agent containing reactive group having unsaturated bond: 7-octenyltrimethoxysilane (referred to as “octenyl” in the fallowing)

### 3. Mixing Process

The components for each example shown in Table 3 were placed in a pressure kneader in the proportions (parts by weight) as indicated, and kneaded for 15 minutes.

Then, the kneaded mixture was removed from the kneader and mixed with a defined amount of a curing catalyst (vulcanizing agent) by using an open roll. Thus, a composition of each example was obtained.

### 4. Production of Cured Sheet

The composition of each example was sandwiched between two polyethylene terephthalate (PET) films and rolled with even-speed rolls in the form of a thin sheet. Subsequently, the sheet-like composition, together with the PET films, were cured between plates in a hot press at 170° C. for 10 minutes. After removing the PET films on both sides, a cured sheet of the composition was produced.

Table 3 shows the results.

TABLE 3

| | | Name of | Name of surface | | | | | | | | | Comp. | Comp. | Comp. | Comp. |
|---|---|---|---|---|---|---|---|---|---|---|---|---|---|---|---|
| Classification | | material | treatment | Ex. 1 | Ex. 2 | Ex. 3 | Ex. 4 | Ex. 5 | Ex. 6 | Ex. 7 | Ex. 8 | Ex. 1 | Ex. 2 | Ex. 3 | Ex. 4 |
| Matrix resin | | A-1 | — | 100 | 100 | 70 | 70 | 70 | 70 | 100 | 100 | 100 | 100 | 100 | 100 |
| | | A-2 | | | | 30 | 30 | 30 | 30 | | | | | | |
| Filler | B-1 | B-1-1 | octyl | 300 | 300 | 300 | 300 | 300 | 300 | | | 300 | 300 | | |
| | | | methacryloxy | | | | | | | | | | | 300 | |
| | | B-1-2 | octyl | | | | | | | 300 | 300 | | | | 300 |
| | B-2 | B-2-1 | decyl | | | | | | | | | 400 | 400 | 400 | |
| | | | methacryloxy | 400 | 400 | 400 | 400 | | | | | | | | |
| | | | octenyl | | | | | 400 | 400 | | | | | | |
| | | B-2-2 | octyl | | | | | | | | | | | | 400 |
| | | | octenyl | | | | | | | 400 | 400 | | | | |
| | B-3 | B-3-1 | octyl | 800 | | | | | | | | 800 | | 800 | |
| | | | methacryloxy | | 800 | 800 | | 800 | | | | | 800 | | |
| | | | octenyl | | | | 800 | | 800 | | | | | | |
| | | B-3-2 | octyl | | | | | | | | 800 | | | | 800 |
| | | | methacryloxy | | | | | | | 800 | | | | | |

| | | | | | | | | | | | | | |
|---|---|---|---|---|---|---|---|---|---|---|---|---|---|
| Vulcanizing agent | — | 1.2 | 1.2 | 1.2 | 1.2 | 1.2 | 1.2 | 1.2 | 1.2 | 1.2 | 1.2 | 1.2 | 1.2 |

| | | | | | | | | | | | | |
|---|---|---|---|---|---|---|---|---|---|---|---|---|
| k | 3.6 | 3.6 | 3.6 | 3.6 | 3.6 | 3.6 | 2.6 | 2.6 | 3.6 | 3.6 | 3.6 | 2.6 |
| Degree of plasticity (mm × 100) | 35 | 33 | 30 | 21 | 16 | 15 | 29 | 26 | 16 | 21 | 80 | 21 |
| Tensile strength (MPa) | 6.2 | 6.4 | 8.3 | 8.8 | 9.0 | 8.6 | 6.0 | 6.1 | 3.0 | 3.7 | 8.7 | 3.8 |
| Thermal conductivity (W/m · K) | 4.6 | 4.6 | 4.6 | 4.6 | 4.6 | 4.6 | 4.8 | 4.7 | 4.6 | 4.6 | 4.6 | 4.7 |

(Note)
The value of each oomponent in Examples and Comparative Examples indicates weight (g).

As can be seen from Table 3, the compositions were flexible and the cured sheets had a tensile strength of 5 MPa or more and a thermal conductivity of 1 W/m·K or more in Examples. Moreover, the cured sheets had a high strength and were able to be handled satisfactorily without the use of a reinforcement sheet such as glass doth

On the other hand, in Comparative Examples 1 and 2, the tensile strength was lower than 5 MPa, since the surface treatment of the filler B-2 did not use the surface treatment agent that contained an alkenyl group. In Comparative Example 3, the degree of plasticity was more than 50, since the surface treatment of the filler B-1 did not use the surface treatment agent that did not contain an alkenyl group. Thus, there was a problem with flexibility. In Comparative Example 4, which was different from Comparative Examples 1 to 3 in the type of filler (i.e., the value k), the tensile strength was lower than 5 MPa, since the surface treatment of the filler B-2 did not use the surface treatment agent that contained an alkenyl group.

### INDUSTRIAL APPLICABILITY

The thermally conductive silicone sheet of the present invention is suitable to be interposed between a heat generating member and a heat dissipating material of electrical and electronic components or the like.

### DESCRIPTION OF REFERENCE NUMERALS

1 Thermal conductivity measuring apparatus
2 Sensor
3a, 3b Sample
4 Tip of the sensor
5 Electrode for applied current
6 Electrode for resistance value (temperature measurement electrode)

1. A thermally conductive silicone composition comprising the following components A to C:
A. a linear organopolysiloxane having a reactive group at each end of a molecular chain;
B. a thermally conductive filler including the following B-1, B-2, and B-3 in an amount of 800 to 2500 parts by mass with respect to 100 parts by mass of the component A; and
C. a curing catalyst in a catalytic amount,
the component B including:
B-1. a thermally conductive filler that has an average particle size of 0.1 μm or more and less than 1.0 μm and is surface treated with a surface treatment agent containing a reactive group having no unsaturated bond;
B-2. a thermally conductive filler that has an average particle size of 1.0 μm or more and less than 10 μm and is surface treated with a surface treatment agent containing a reactive group having an unsaturated bond; and
B-3: a thermally conductive filler that has an average particle size of 10 μm or more and 100 μm or less and is surface treated with at least one selected from the surface treatment agent containing a reactive group having no unsaturated bond and the surface treatment agent containing a reactive group having an unsaturated bond.

2. The thermally conductive silicone composition according to claim 1, wherein the surface treatment agent containing a reactive group having no unsaturated bond is a silane coupling agent that does not contain an alkenyl group.

3. The thermally conductive silicone composition according to claim 1, wherein the surface treatment agent containing a reactive group having no unsaturated bond is a silane coupling agent that contains an alkyl group.

4. The thermally conductive silicone composition according to claim 1, wherein the surface treatment agent containing a reactive group having an unsaturated bond is at least one selected from the group consisting of a silane coupling agent containing an alkenyl group, a silane coupling agent containing an acrylic group, a silane coupling agent containing a methacryloxy group, a silane coupling agent containing a vinyl group, and a silane coupling agent containing a styrene group.

5. The thermally conductive silicone composition according to claim 1, wherein a degree of plasticity of the thermally conductive silicone composition before curing is 1 to 50.

6. The thermally conductive silicone composition according to claim 1, wherein a linear terminal-reactive polysiloxane of the component A is represented by the following general formula (1):
X[Si(CH₃)₂—O—]ₙSi(CH)₂—Y (1)
(where a degree of polymerization n is in the range of 5 to 2100 and end groups X, Y are vinyl groups.)

7. The thermally conductive silicone composition according to claim 1, wherein a mixing ratio of B-1, B-2, and B-3 is determined by (total surface area of B-3+total surface area of B-2)=k×(total crass section of B-1), where k is 1 to 5.

8. The thermally conductive silicone composition according to claim 1, wherein the curing catalyst is an organic peroxide.

9. The thermally conductive silicone composition according to claim 1, wherein the thermally conductive filler of the component B contains at least one selected from the group consisting of aluminum oxide, zinc oxide, silicon oxide, silicon carbide, aluminum nitride, and boron nitride.

10. The thermally conductive silicone composition according to claim 1, wherein a mixing ratio of B-1, B-2, and B-3 is such that 150 to 450 parts by mass of B-1, 250 to 550 parts by mass of B-2, and 400 to 1500 parts by mass of B-3 are blended with respect to 100 parts by mass of the component A.

11. A thermally conductive silicone sheet comprising a thermally conductive silicone composition,
the thermally conductive silicone composition comprising the following components A to C:
A. a linear organopolysiloxane having a reactive group at each end of a molecular chain;
B. a thermally conductive filler including the following B-1, B-2, and B-3 in an amount of 800 to 2500 parts by mass with respect to 100 parts by mass of the component A; and
C. a curing catalyst in a catalytic amount,
the component B including:
B-1. a thermally conductive filler that has an average particle size of 0.1 μm or more and less than 1.0 μm and is surface treated with a surface treatment agent containing a reactive group having no unsaturated bond;
B-2. a thermally conductive filler that has an average particle size of 1.0 μm or more and less than 10 μm and is surface treated with a surface treatment agent containing a reactive group having an unsaturated bond; and
B-3: a thermally conductive filler that has an average particle size of 10 μm or more and 100 μm or less and is surface treated with at least one selected from the surface treatment agent containing a reactive group having no unsaturated bond and the surface treatment agent containing a reactive group having an unsaturated bond,
wherein the thermally conductive silicone composition is molded into a sheet and the sheet is thermally cured, and
a tensile strength of the thermally conductive silicone sheet is 5 MPa or more.

12. The thermally conductive silicone sheet according to claim 11, wherein a thermal conductivity of the thermally conductive silicone sheet is 1 W/m·K or more.

13. The thermally conductive silicone sheet according to claim 11, wherein the thermally conductive silicone sheet does not include a reinforcement sheet.

14. A method for producing a thermally conductive silicone sheet, comprising:
uniformly mixing a composition comprising the following components A to C;
molding the composition into a sheet; and
thermally curing the sheet,
A. a linear organopolysiloxane having a reactive group at each end of a molecular chain;
B. a thermally conductive filler including the following B-1, B-2, and B-3 in an amount of 800 to 2500 parts by mass with respect to 100 parts by mass of the component A; and
C. a curing catalyst in a catalytic amount,
the component B including:
B-1. a thermally conductive filler that has an average particle size of 0.1 μm or more and less than 1.0 μm and is surface treated with a surface treatment agent containing a reactive group having no unsaturated bond;
B-2. a thermally conductive filler that has an average particle size of 1.0 μm or more and less than 10 μm and is surface treated with a surface treatment agent containing a reactive group having an unsaturated bond; and
B-3: a thermally conductive filler that has an average particle size of 10 μm or more and 100 μm or less and is surface treated with at least one selected from the surface treatment agent containing a reactive group having no unsaturated bond and the surface treatment agent containing a reactive group having an unsaturated bond.

15. The thermally conductive silicone sheet according to claim 11, wherein the surface treatment agent containing a reactive group having no unsaturated bond is a silane coupling agent that does not contain an alkenyl group.

16. The thermally conductive silicone sheet according to claim 11, wherein the surface treatment agent containing a reactive group having no unsaturated bond is a silane coupling agent that contains an alkyl group.

17. The thermally conductive silicone sheet according to claim 11, wherein the surface treatment agent containing a reactive group having an unsaturated bond is at least one selected from the group consisting of a silane coupling agent containing an alkenyl group, a silane coupling agent containing an acrylic group, a silane coupling agent containing a methacryloxy group, a silane coupling agent containing a vinyl group, and a silane coupling agent containing a styrene group.

18. The thermally conductive silicone sheet according to claim 11, wherein a degree of plasticity of the thermally conductive silicone composition before curing is 1 to 50.

19. The thermally conductive silicone sheet according to claim 11, wherein a linear terminal-reactive polysiloxane of the component A is represented by the following general formula (1):
X[Si(CH₃)₂—O—]ₙSi(CH₃)₂—Y (1)
(where a degree of polymerization n is in the range of 5 to 2100 and end groups X, Y are vinyl groups.)

20. The thermally conductive silicone sheet according to claim 11, wherein a mixing ratio of B-1, B-2, and B-3 is determined by (total surface area of B-3+total surface area of B-2)=k×(total cross section of B-1), where k is 1 to 5.
